(19) United States
(12) Patent Application Publication
(10) Pub. No.: US 2020/0190386 A1
(43) Pub. Date: Jun. 18, 2020

(54) DRILLING FLUID COMPOSITIONS AND METHODS OF USE THEREOF

(71) Applicant: Roger A. Daar, JR., The Woodlands, TX (US)

(72) Inventor: Roger A. Daar, JR., The Woodlands, TX (US)

(21) Appl. No.: 16/708,914

(22) Filed: Dec. 10, 2019

Related U.S. Application Data
(60) Provisional application No. 62/778,469, filed on Dec. 12, 2018.

(51) Int. Cl. C09K 8/38; C09K 8/34

(52) U.S. Cl. CPC C09K 8/38; C09K 8/34

(57) ABSTRACT

A composition for use in performing drilling operations of boreholes is disclosed. The composition is a mixture of nitrogen gas or carbon dioxide gas, Y-grade fluids mixture and a surfactant foaming agent. In other embodiments, a high density, non-toxic, inert gas compound can be added to the mixture. Alternatively, a flame retardant chemical can be added to the mixture, as well as a gas or chemical additive that alters the mixture's thermal properties.

### BACKGROUND OF THE INVENTION

Conventional foam drilling fluids use either air or low purity nitrogen gas, together with water and a water-based soap, to create foam. The use of water in drilling fluids can cause well productivity problems by inducing a type of formation damage called “clay swelling”. Clay swelling occurs when clay minerals contained in reservoir rock pore networks contact the water in drilling fluid via the drilling fluid filtrate. After contact with the filtrate, these swollen clay minerals can occupy a volume several orders of magnitude greater than their unaltered state. This clay volume expansion creates an annulus of reduced rock permeability surrounding the, the severity of which depends upon filtrate penetration depth, filtrate salinity, contact time between filtrate and clay minerals, and the type of clay minerals.

This permeability damaged annulus contains pore networks with constricted cross-sectional areas and creates an additional pressure drop that impedes flow from the reservoir into the wellbore and reduces oil and gas well productivity.

Removing water from the drilling fluid composition removes the aqueous drilling filtrate and the means by which clay minerals swell and block pore throats during drilling operations.

The use of water in conventional drilling muds usually requires the addition of pH control chemicals. These chemicals can penetrate the reservoir via mud filtrate and alter the surface tension between the filtrate/connate water mixture and residual oil globules remaining in the near wellbore pore networks. Where clay swelling physically reduces rock permeability, emulsions form a low mobility, high viscosity annulus around the wellbore. This high viscosity annulus reduces the relative permeability to the oil or gas phase existing beyond it and oil and gas must flow through this region of high pressure drop to enter the wellbore.

Conventional water and water-in-oil emulsion drilling muds contain bentonite particles. These particles form a mud cake on permeable reservoir rock surfaces surrounding the wellbore. This mud cake is a type of formation damage caused when solid particles in the drilling mud plate out against the wellbore face as mud filtrate, driven by differential over-balanced pressure between the wellbore and the reservoir, enters the permeable reservoir rock. These solids collect at the pore throat entry points and accumulate to form this low permeability mud cake. This mud cake, beneficial to reducing filtrate loss into permeable rock during drilling operations, can be difficult to remove and even its partial existence creates an additional pressure drop that impedes oil and gas flow from the reservoir into the wellbore.

Conventional drilling and completion fluids generally must be removed from the reservoir within a short time frame after drilling operations are completed or the mud filtrate, given heat, pressure and time, can induce formation damage independent of drilling and completion operations. Well clean-up and flow-back are often delayed for various reasons such as unfinished connecting flowline construction, unfinished gathering plants, no flow-back tanks available, etc.

Limitations imposed by these problems are overcome using the inventive composition which does not contain water. The use of the inventive composition will eliminate chemical and physical mechanisms by which clay swelling, emulsion formation, and mud cake deposition occur. Further, with no water or solid bentonite in the inventive composition, oil and gas wells are likely to produce at higher rates than if these same wells were drilled with conventional drilling fluids. Wells drilled using the inventive composition are also expected to require fewer remedial stimulation operations.

### SUMMARY OF THE INVENTION

In a first embodiment of the invention, the present invention provides for a composition comprising a mixture of nitrogen gas or carbon dioxide gas, Y-grade fluids mixture, and a surfactant foaming agent.

In a second embodiment of the invention, there is disclosed a composition comprising a mixture of nitrogen gas or carbon dioxide gas, Y-grade fluids mixture, a surfactant foaming agent, and a high density, non-toxic, inert gas compound.

In a third embodiment of the invention, there is disclosed a composition comprising a mixture of nitrogen gas or carbon dioxide gas, Y-grade fluids mixture, and a flame retardant chemical.

In a fourth embodiment of the invention, there is disclosed a composition comprising a mixture of nitrogen gas or carbon dioxide gas, Y-grade fluids mixture, and a higher quality foam, as well as containing gas and/or chemical additives that alter its thermal properties.

In another embodiment of the invention, there are disclosed improved methods for performing drilling operations of boreholes comprising adding the inventive compositions to the boreholes.

In general, Y-grade fluids comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

The first composition, namely the mixture of nitrogen gas or carbon dioxide gas, Y-grade fluids mixture, and a surfactant foaming agent can be tailored or tuned to address the drilling environment and drill cuttings recovery requirements of individual hydrocarbon reservoirs. For example, the physical properties of the foam can be altered by adjusting the gas/liquid phase volume ratio (i.e., foam quality), altering the gas and/or liquid phase compositions, heating or cooling the foam components, and adding additional liquid or gas phase chemicals and/or solid state nanoparticles.

In the alternative embodiments of the invention, the second embodiment of the invention adds a high density, non-toxic, inert gas compound to the basic composition. By adding the high density compound, the composition can be employed in deeper drilling operations. For example, the addition of sulphur hexafluoride to the basic mixture of nitrogen gas or carbon dioxide gas, Y-grade fluids mixture, and a surfactant foaming agent will allow the drilling fluid to achieve greater working depths in higher pressure reservoirs.

Alternatively, in the third embodiment, the well operator may have safety concerns about flammable drilling fluids employed in under-balanced drilling operations. Fugitive hydrocarbon emissions from the BOP (blowout preventer) stack can create a fire hazard, so the addition of a flame retardant chemical can reduce this fire hazard at the drilling site.

In the fourth embodiment, the drilling conditions are in much colder climates where permafrost exists. Conventional liquid drilling mud can induce permafrost thaw around the wellbore in the upper hole section when exposed to higher temperature drilling mud for extended periods. The use of a chemical additive to the mixture of nitrogen gas or carbon dioxide gas, Y-grade fluids mixture, and a surfactant foaming agent can alleviate this thawing problem and its associated sloughing. The added chemicals along with nitrogen gas can result in more stable boreholes that deliver less sloughing, fewer key seats, competent cement bonds between the frozen soil horizon and the surface casing, and fewer abandoned boreholes.

The higher densities that can be achieved in the inventive composition will produce more downhole back-pressure against the reservoir and result in lower surface foam returns pressure. The reduced surface returns pressure can improve expected safety performance by delivering fewer well “events” during drilling operations. The addition of the higher density components could also extend the depth and pressure range where foamed drilling fluids could be employed.

### DETAILED DESCRIPTION OF THE INVENTION

The advantages realized by the compositions and methods of the present invention overcome the disadvantages of conventional drilling muds as no water is employed in the compositions of the present invention. Further, no solid particulate bentonite is used. The basic composition as disclosed in the first embodiment uses only gaseous and volatile hydrocarbons. The compositions of the present invention can be used in under-balanced pressure operations. Further, these compositions can be flared as necessary provided no flame retardant is added. The overall effect of the basic composition is that after drilling operations are performed, the basic components can be produced into the gathering infrastructure where they can be separated and reused or sold. The basic composition can be injected into a hydrocarbon reservoir to assist in controlling working surface pressure during certain drilling operations without inducing the formation damage associated with clay swelling, emulsions, or mud cake.

The compositions of the present invention have the further following advantages over the conventional drilling foams and muds. Because the compositions inhibit formation damage, they prevent the additional pressure drop in the wellbore created when drilling fluid filtrate invades the near wellbore reservoir pore network during drilling operations.

The compositions would likely not induce formation damage and better retain in-situ permeability in the reservoir rock surrounding the wellbore. This reduced formation damage would improve oil and gas production rates over those achieved using conventional drilling fluids.

Furthermore, production from oil wells could be stimulated by injection of the inventive compositions during over-balanced pressure operations.

As the present invention would minimize formation damage, it thereby would also reduce the need to subsequently perform expensive remedial stimulation operations. Further, well cleanup and flow-back operations could be shortened or eliminated after well handover to field operations.

Tank and pit overflow situations could be minimized as foam returns could be flared provided no flame retardant chemical is added.

The components of the inventive compositions can be produced into the production gathering infrastructure and recovered for reuse or subsequent sale.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

What is claimed is:

1. A composition comprising a mixture of nitrogen gas or carbon dioxide gas, Y-grade fluids mixture, and a surfactant foaming agent.

2. A composition comprising a mixture of nitrogen gas or carbon dioxide gas, Y-grade fluids mixture, a surfactant foaming agent and a high density, non-toxic, inert gas compound.

3. A composition comprising a mixture of nitrogen gas or carbon dioxide gas, Y-grade fluids mixture, and a flame retardant chemical.

4. A composition comprising a mixture of nitrogen gas or carbon dioxide gas, Y-grade fluids mixture, and a higher quality foam, as well as containing gas and/or chemical additives that alter its thermal properties.

5. An improved method for performing drilling operations of boreholes comprising adding a composition selected from the group of mixtures comprising a mixture of nitrogen gas or carbon dioxide gas, Y-grade fluids mixture, and a surfactant foaming agent; nitrogen gas or carbon dioxide gas, Y-grade fluids mixture, a surfactant foaming agent and a high density, non-toxic, inert gas compound; of nitrogen gas or carbon dioxide gas, Y-grade fluids mixture, and a flame retardant chemical; and nitrogen gas or carbon dioxide gas, Y-grade fluids mixture, and a higher quality foam, as well as containing gas and/or chemical additives that alter its thermal properties.
